(19) United States
(12) Patent Application Publication
(10) Pub. No.: US 2013/0105747 A1
(43) Pub. Date: May 2, 2013

(54) METHODS FOR TENSIONING A MEMBRANE AND APPARATUSES THEREOF

(71) Applicant: Scot C. GALLIHER, Millerton, NY (US)

(72) Inventor: Scot C. GALLIHER, Millerton, NY (US)

(21) Appl. No.: 13/658,509

(22) Filed: Oct. 23, 2012

Related U.S. Application Data
(60) Provisional application No. 61/553,395, filed on Oct. 31, 2011.

(51) Int. Cl. B66F 3/00

(52) U.S. Cl. 254/133 R

(57) ABSTRACT

A method for tensioning a membrane includes affixing a first wire to a first portion of the membrane and affixing a second wire to a second portion of the membrane. The membrane is tensioned between the first wire and the second wire by applying a first current in a first direction through the first wire and applying a second current in a second direction through the second wire, so that repulsive magnetic fields are generated between the first wire and the second wire.

### CROSS REFERENCE TO RELATED CO-PENDING APPLICATIONS

This application claims the benefit of U.S. provisional application Ser. No. 61/553,395 filed Oct. 31, 2011 and entitled “METHODS FOR TENSIONING A MEMBRANE AND APPARATUSES THEREOF”, the contents of which are expressly incorporated herein by reference.

### FIELD

This technology generally relates to methods for tensioning a membrane and, more particularly, relates to methods for tensioning a membrane through the use of magnetic fields and apparatuses thereof.

### BACKGROUND

Space-based optical systems and other remote sensing programs have identified a need for large, lightweight, efficient designs for large-scale deployable optics. Performance of these systems improves as aperture increases. Traditionally, reflecting telescopes for terrestrial observatories have been built around simple monolithic glass primary mirrors. However, when produced in sizes larger than five to six meters in diameter, such monolithic mirrors are extremely heavy, expensive, difficult to manufacture, difficult to handle, and inappropriate for space applications. Moreover, due to launch vehicle size and volume constraints, structures larger than four to five meters in diameter must be assembled in space. Thus, lightweight deployable mirrors are needed because they facilitate a large savings in payload mass, which in turn leads to tremendous savings in launch cost. The issues of weight and assembly in space apply equally to other systems that attempt to intercept large amounts of radiation in space, such as photon sieves, diffraction gratings, solar sails, and solar collectors.

One approach for large lightweight deployable space radiation interceptors is using membranes. According to the book “Recent Advances in Gossamer Spacecraft”, 2006, American Institute of Aeronautics and Astronautics”, the term ‘membrane’ indicates the mechanical response is dominated by extension rather than bending. As used in this application, a membrane is a material with plastic properties that has a length and width orders of magnitude larger than its thickness, is not stretchable, and can be bent in the direction of its thickness.

Membranes involve the utilization of films or foils as the active material. Such membranes require some type of mechanism to hold the membrane in the proper shape necessary to intercept and/or concentrate radiation incident on the membrane. For optical concentration of the radiation to a focal point, a number of mechanisms have been proposed including pressure augmented membrane mirrors (PAMM), stretched membranes with electrostatic curvature (SMEC) mirrors, and the like. Because such frames have significant weight or bulk and must be assembled in space due to their size, they mitigate the cost advantages of utilizing a lightweight membrane. Alternative lightweight frameworks that can form a membrane into a shape suitable for various systems are desirable.

### SUMMARY

A method for tensioning a membrane includes affixing a first wire to a first portion of the membrane and affixing a second wire to a second portion of the membrane. The membrane is tensioned between the first wire and the second wire by applying a first current in a first direction through the first wire and applying a second current in a second direction through the second wire, so that repulsive magnetic fields are generated between the first wire and the second wire.

In some embodiments, the method further includes affixing the first wire about a perimeter of at least a first portion of the membrane. A second wire is affixed about a perimeter of at least a second portion of the membrane, wherein the second portion is contained within the first portion. In some of these embodiments, the first wire and the second wire are positioned in concentric circles about the membrane.

In some embodiments, at least one surface of the membrane includes a reflective material. In some of these embodiments, one or more of the following features may also be included. The tensioned membrane may form a shape for focusing radiation incident on the reflective surface of the membrane onto a focal point. The method may further include focusing radiation incident on the reflective surface of the membrane onto a focal point.

In some embodiments, one or more of the following features may also be included. At least one surface of the membrane may include an electrically conductive material. The at least one surface of the membrane may include a metallic material. The membrane may include a flexible material. Each of the first wire and the second wire may include a superconducting material. Each of the first current and the second current may be direct current. Each of the first current and the second current may be alternating current.

In some embodiments, affixing includes using an adhesive material. In some embodiments, affixing includes photolithographically applying the first wire and the second wire to the membrane. In some embodiments, the first and second wires are embedded in the membrane material.

In some embodiments, the tensioned membrane forms a parabolic shape. In some of these embodiments, the first wire and the second wire are positioned in concentric circles about the membrane.

In some embodiments, the tensioned membrane includes a diffraction grating.

In some embodiments, the first wire and the second wire are positioned in concentric spiral shaped paths about the membrane.

In some embodiments, a bus feed is used for providing current to the first and second wires.

An exemplary apparatus for tensioning a membrane includes a membrane, a first wire, and a second wire. The first wire is affixed to a first portion of the membrane. The first wire is configured to receive a first current in a first direction. The second wire is affixed to a second portion of the membrane. The second wire is configured to receive a second current in a second direction. Applying the first current and the second current generates repulsive magnetic fields tensioning the membrane between the first wire and the second wire.

In some embodiments, the first wire is affixed about a perimeter of at least a first portion of the membrane. The second wire is affixed about a perimeter of at least a second portion of the membrane wherein the second portion is contained within the first portion. In some of these embodiments, the first wire and the second wire are positioned in concentric circles about the membrane.

In some embodiments, the at least one surface of the membrane includes a reflective material. In some of these embodiments, the tensioned membrane forms a shape for focusing radiation incident on the reflective surface of the membrane onto a focal point.

In some embodiments, one or more of the following features may also be included. At least one surface of the membrane may include an electrically conductive material. The at least one surface of the membrane may include a metallic material. The membrane may include a flexible material. Each of the first wire and the second wire may include a superconducting material. Each of the first current and the second current may be direct current. Each of the first current and the second current may be alternating current.

In some embodiments, affixed includes using an adhesive material. In some embodiments, affixed includes photolithographically applying the first wire and the second wire to the membrane.

In some embodiments, the tensioned membrane forms a parabolic shape. In some of these embodiments, the first wire and the second wire are positioned in concentric circles about the membrane.

In some embodiments, the tensioned membrane includes a diffraction grating. The diffraction grating includes a plurality of concentric circular rulings with gaps between them. The size of the gaps between the circular rulings decreases with increasing distance from the center of the grating, so that the incident radiation is bent at lesser angles towards the center of the grating and greater angles towards the perimeter of the grating.

In another embodiment, the invention provides a method for tensioning a portion of a membrane by affixing a bent wire to a portion of the membrane and then applying a current in a first direction through the bent wire, thereby straitening the bent wire and tensioning the portion of the membrane.

This technology provides effective and efficient methods and apparatuses for tensioning a membrane. Beneficially, this technology provides a cost-effective tensioning methodology by which a membrane may be framed without adding undue weight on the membrane.

### BRIEF DESCRIPTION OF THE DRAWINGS

The foregoing and other objects, features, and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a flow diagram illustrating an exemplary method for tensioning a membrane;

FIG. 2 is a schematic of an exemplary tensioned parabolic dish membrane apparatus;

FIG. 3A is a diagram depicting magnetic fields generated by a current-carrying wire;

FIG. 3B is a diagram depicting magnetic forces around a wire and around bends in the wire.

FIG. 3C is a diagram depicting attractive magnetic fields generated by two parallel wires having currents travelling in the same direction;

FIG. 3D is another diagram depicting attractive magnetic fields generated by two parallel wires having currents travelling in the same direction;

FIG. 3E is a diagram depicting repulsive magnetic fields generated by two parallel wires having currents travelling in opposite directions;

FIG. 4 is a schematic cross-sectional view of the wires attached to the surface of the exemplary membrane tensioning apparatus depicted in FIG. 2; and

FIG. 5-FIG. 7 are schematic diagrams of exemplary wiring attachment schemes for the membrane tensioning apparatus depicted in FIG. 2.

### DETAILED DESCRIPTION

This technology is directed to methods and apparatuses for tensioning and/or shaping a membrane. Such membranes may include, for example, those utilized in space-based optical systems and other remote sensing programs.

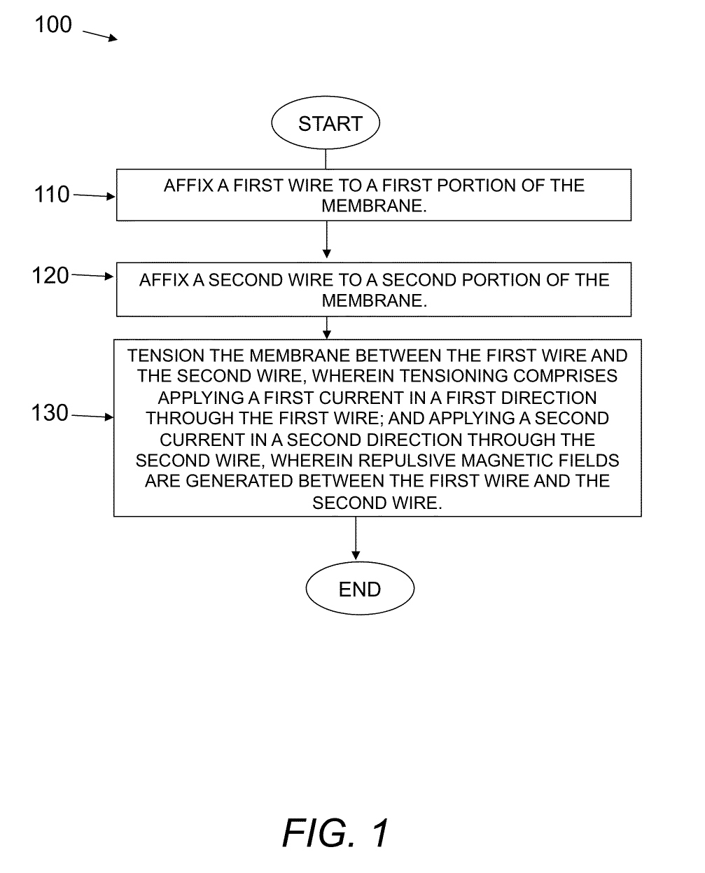

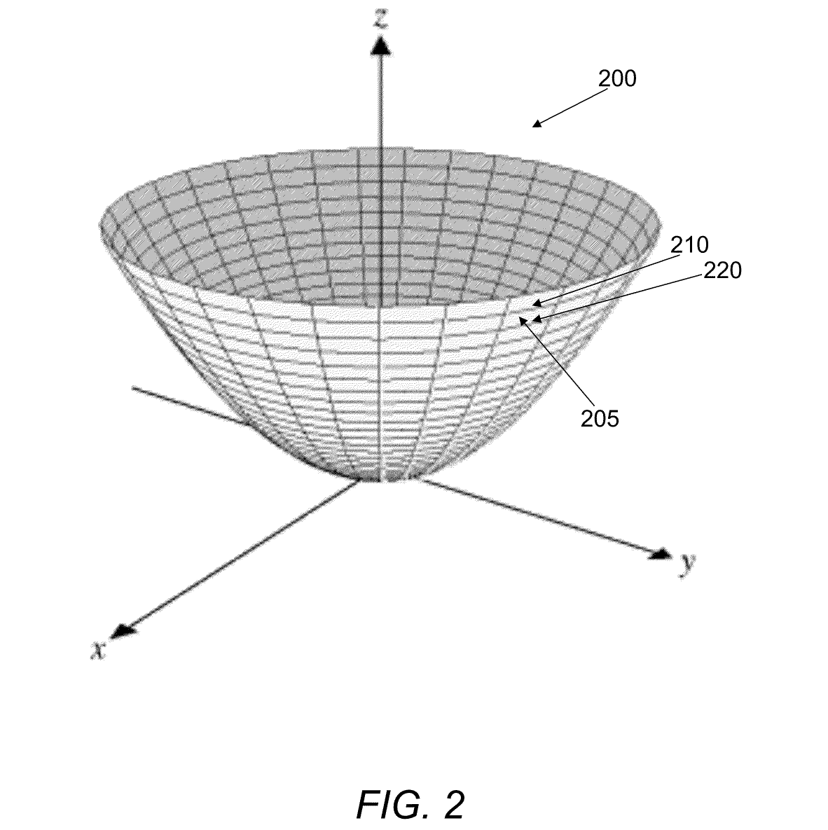

FIG. 1 is a flow diagram illustrating an exemplary method 100 for tensioning a membrane. FIG. 2 is a schematic of an exemplary tensioned parabolic dish membrane apparatus 200. With reference to FIGS. 1-2, the method 100 includes affixing a first wire 210 to a first portion of the membrane 205 (block 110) and affixing a second wire 220 to a second portion of the membrane 205 (block 120). The membrane 205 is tensioned between the first wire 210 and the second wire 220 by applying a first current in a first direction through the first wire 210 and applying a second current in a second direction through the second wire 220, wherein repulsive magnetic fields are generated between the first wire 210 and the second wire 220 (block 130).

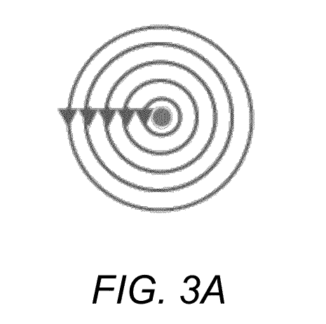

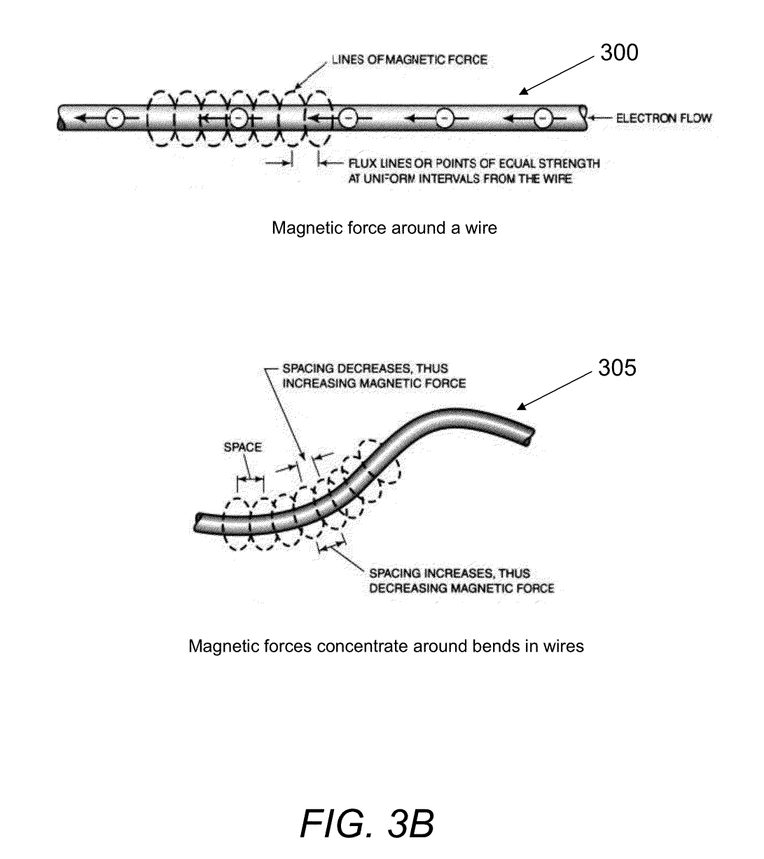

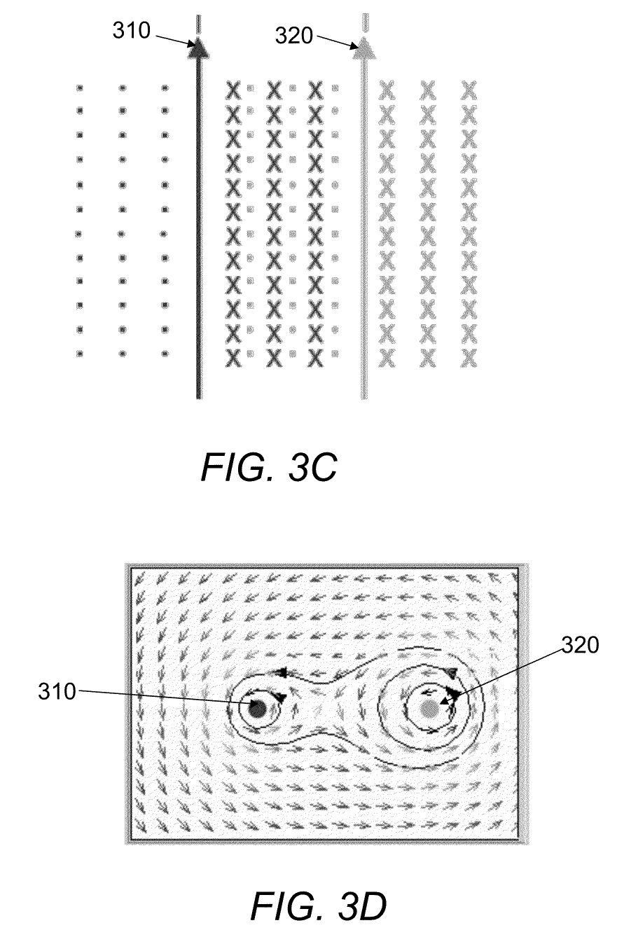

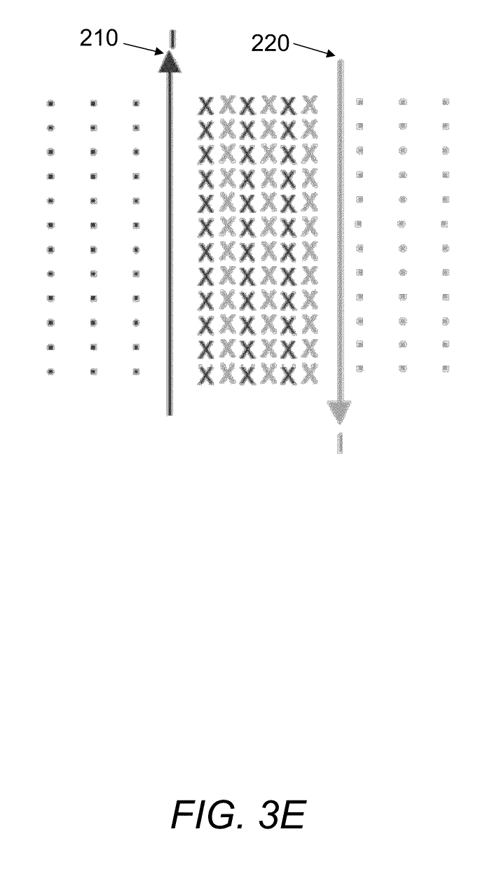

FIGS. 3A-3E depict magnetic fields generated by current-carrying wires 210-220 and the effects of those magnetic fields upon adjacent wires. Circular magnetic fields are generated around current-carrying wires. The strength of these fields varies directly with the size of the current flowing through the wire and inversely to the distance from the wire. In FIG. 3A, the solid circle in the center represents a cross-section of a current-carrying wire in which the current is coming out of the plane of the paper. The concentric circles surrounding the wire's cross-section represent magnetic field lines. The rule to determine the direction of the magnetic field lines is called the right hand curl rule. In this rule, one's thumb points in the direction of the current, while one's fingers curl in the direction of the magnetic field B_{⊥}. The equation to calculate the strength of the external perpendicular magnetic field is:

B_{⊥}=μₒI/(2πr), measured in T, (1)

where μₒ=4π+10⁻⁷ H/m=permeability of free space; I=current flowing through the wire measured in A; and r=distance from the wire, measured in meters.

Referring to FIG. 3B, when electrons flow through a wire, they create lines of magnetic force that circle around the line of flow. Such lines of magnetic force are referred to as magnetic flux lines. These lines space themselves evenly along current-carrying wire 300. If, on the other hand, the wire 305 is bent, the flux lines on one side are compressed together, and those on the other side are stretched out. The unevenly spaced flux lines try to straighten the wire so that the lines can be evenly spaced once again. Therefore, in some embodiments, if a single bent wire is affixed to a portion of a membrane, applying a current to the bent wire will result in tensioning of the membrane. In some such embodiments, the single wire may be affixed about a perimeter of at least a portion of the membrane.

If two current-carrying wires are adjacent to each other, their respective magnetic fields either attract or repel each other. Referring to FIGS. 3C-3D, if two current-carrying wires 310-320 have currents travelling in the same direction, the magnetic fields generated by those currents between the wires will both point in opposite directions resulting in the wires attracting each other.

However, referring to FIG. 3E, if two parallel wires 210-220 have currents travelling in opposite directions, the magnetic fields generated by those currents between the wires will point in the same direction, in this case, into the plane of the page. Thus, these wires would repel each other.

The formula used to calculate these attractive or repulsive forces is:

F=B_{⊥}IL, where (2)

B_{⊥}=the external, perpendicular magnetic field measured in T; I=the current measured in A; and L=length of the current segment (in meters) that lies in the external magnetic field B_{⊥}. More specifically:

F=B_{⊥}IL

F₁₂=(μₒI₁/2πr)I₂L₂

F₁₂=(μₒ/2πr)I₁I₂L₂

F₁₂=(4π×10⁻⁷/2πr)I₁I₂L₂

F₁₂=(2×10⁻⁷/r)I₁I₂L₂ (3)

where F₁₂=the force on wire 2 caused by its presence in the magnetic field of wire 1; I₁=the current flowing in wire 1; I₂=the current flowing in wire 2; L₂=the length of the current segment of wire 2 in the field of wire 1; and r=the distance between the wires.

Utilizing these equations, and referring back to FIG. 2, wires 210 and 220 may be affixed to membrane 205 at any suitable distance from one another, with correspondingly suitable currents applied in opposite directions, such that repulsive magnetic fields tension the membrane 205 between wire 210 and wire 220. In some embodiments, wires 210 and 220 are affixed to the membrane 205 using an adhesive material. Such an adhesive material may include, but is not limited to, a glue. Alternatively or additionally, wires 210 and 220 may be affixed to the membrane 205 by mechanical means. For example, wires 210 and 220 may be sewn in to the membrane 205 or may be affixed to the membrane 205 by any suitable mechanical means. Alternatively or additionally, affixing may include chemical creation or deposition of wires 210 and 220 on or in the membrane 205. For example, wires 210 and 220 may be photolithographically applied to the membrane 205. In another example, the conductive channel may be built up on or in the membrane 205. Alternatively or additionally, wires 210 and 220 may be embedded into the membrane 205.

In some embodiments, at least one surface of the membrane 205 includes an electrically conductive material. In some of these embodiments, the at least one surface of the membrane 205 includes a metallic material. In some embodiments, the membrane includes a flexible material. In some embodiments, at least one surface of the membrane 205 includes a reflective material. In some embodiments, at least one surface of the membrane 204 includes an opaque material. In some embodiments, the membrane includes a transmissive material.

In some embodiments, the tensioned membrane 205 may form a shape for concentrating radiation incident on the membrane 205. In some of these embodiments, the tensioned membrane 205 forms a shape for focusing radiation incident on the surface of the membrane onto a focal point. In some of these embodiments, at least one surface of the membrane 205 includes a reflective material. In some of these embodiments, method 100 further includes focusing radiation incident on the reflective surface of the membrane onto a focal point. In some embodiments, the membrane 205 is a flat circular shape, a parabolic shape, or any other shape suitable for focusing incident radiation.

In some embodiments, the method 100 further includes affixing the first wire 210 about a perimeter of at least a first portion of the membrane 205 and affixing the second wire 220 about a perimeter of at least a second portion of the membrane 205, wherein the second portion is contained within the first portion. In some such embodiments, the tensioned membrane 205 forms a parabolic shape. In some of these embodiments, the first wire 210 and the second wire 210 are positioned in concentric circles about the membrane 205, as depicted in FIG. 2.

In some embodiments, at least one surface of the membrane 205 includes polymide plastic, nickel, gold-coated nickel, Mylar®, aluminum-coated Mylar, Kapton®, Melinex, polymeric materials, CP1, or any other suitable material, or any combination thereof.

In some embodiments, the membrane 205 has a thickness between 10-20 μm with thickness variations of about 0.1 μm and a width up to tens of meters. In other embodiments, the membrane 205 has any suitable thickness, thickness variation, and width. In some embodiments, the tensioned membrane 205 includes a diffraction grating.

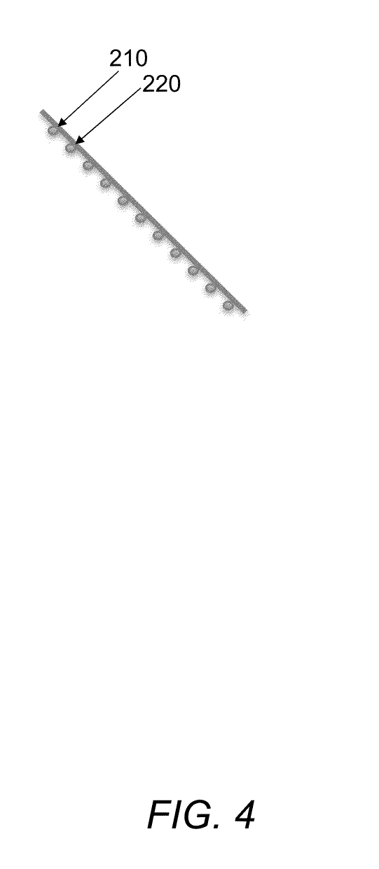

FIG. 4 is a schematic cross-sectional view of the wires (e.g., wires 210 and 220) attached to the surface of the exemplary membrane tensioning apparatus 200 depicted in FIG. 2. Referring to FIGS. 2 and 4, in some embodiments, a plurality of wires (e.g., wires 210-220) may be affixed to the parabolic membrane 205 in concentric circles of increasing radius from the center of the membrane 205 out to the edge of the membrane 205. In some embodiments, the spacing of two or more wires and their size relative to the thickness of the membrane 205 are determined by the specific application of the membrane tensioning apparatus, the shape to be created, and/or are other limitations imposed by equation (3), and/or the force of deformation of the membrane material 205 and/or its tensile strength.

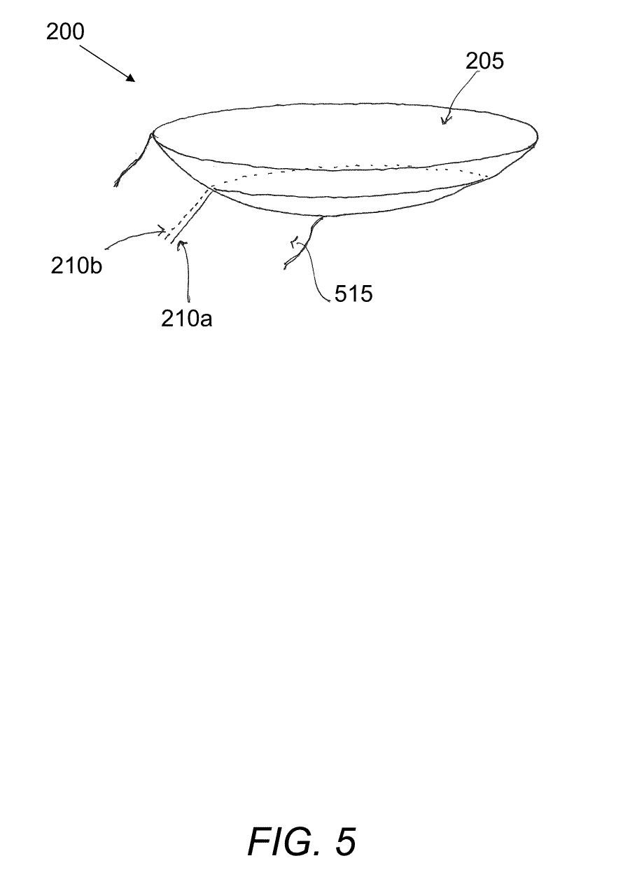

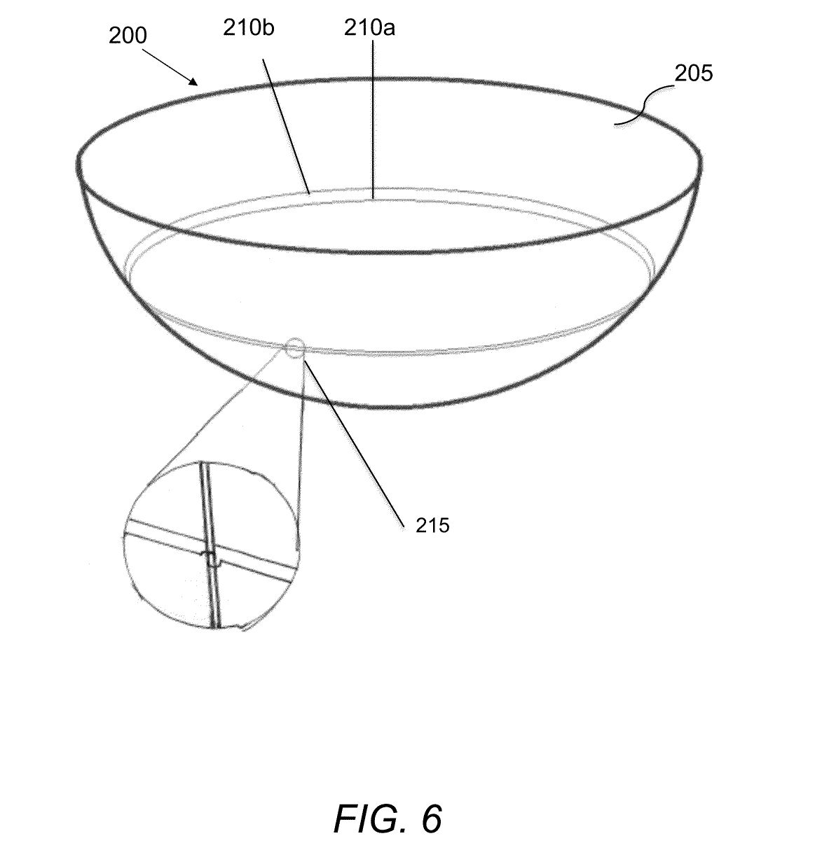

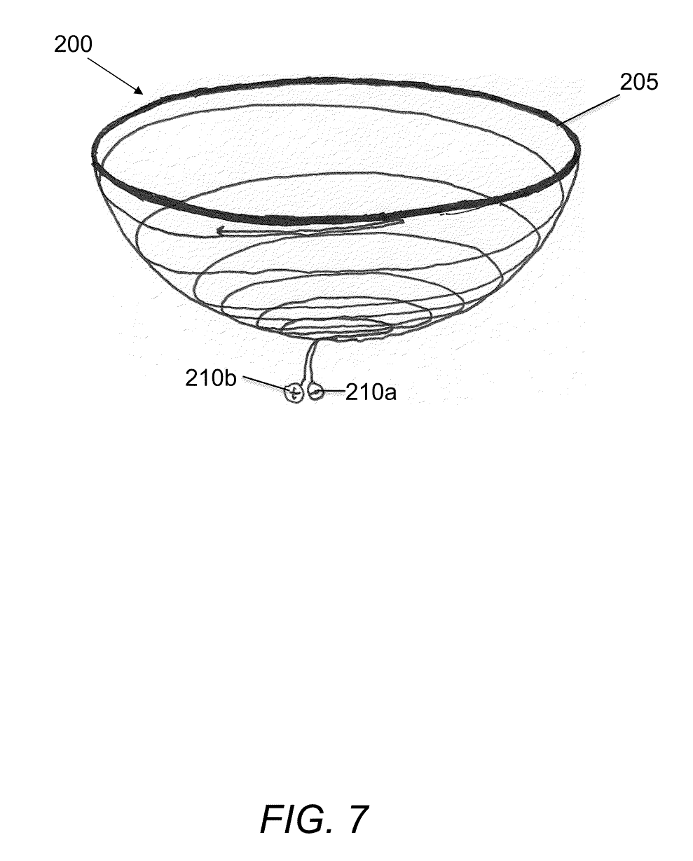

FIG. 5 is a schematic of an exemplary wiring attachment scheme for the membrane tensioning apparatus 200 depicted in FIG. 2. Referring to FIGS. 2 and 5, in some embodiments, one or more wires (e.g., wires 210-220) are made of a superconducting material. In some embodiments, two or more wires are spaced very closely together. In some embodiments, a membrane tensioning apparatus 200 may include one or more attachment points where current is fed into each wire. In the embodiment of FIG. 6, a bus feed 215 is used for feeding current into the wires 210a, 210b. The circle pointing to the bus feed 215 depicts an enlarged detailed view of the bus feed connection 215. In the embodiment of FIG. 7, wires 210a, 210b run along spiral-shaped paths around the membrane 205. In some embodiments, an applied current may include direct current. In some embodiments, an applied current may include alternating current. When the current is turned on, a magnetic field forms around each wire. In the exemplary parabolic dish membrane 205 depicted in FIGS. 2 and 5, the effect of the magnetic field on each wire is to create a force that causes the wire to try to straighten out. Because the wire is affixed to the membrane material 205, the result will be for the membrane 205 to expand outward until it stretches as large as the membrane 205 allows. In addition, if the current is run in the proper direction and appropriately adjusted for strength (e.g., in accordance with equation (3)), the magnetic fields from adjacent wires will interact with each other in such a way that the membrane 205 will form the parabolic shape (or any other suitable shape).

The wiring attachment scheme will vary according to the desired shape of the tensioned membrane 205. For example, in the case of the parabolic dish membrane 205 depicted in FIG. 5, the wiring attachments 201a, 210b may be made along a radial line, using another attachment membrane 515 whose edge is cut to match the cross-section profile of the dish membrane 205. One or more wires may run along one side of the attachment membrane 515 and transfer to the dish membrane 205, where the wire may then run along one of the concentric lines around the dish membrane 205. Then, the wire may transfer back to the attachment membrane 515 on the opposite side. Although FIG. 5 depicts a scenario in which each affixed wire is individually controlled, any suitable attachment scheme may be utilized. For example, in an embodiment utilizing three or more affixed wires, there may be only two feed wires. A first feed wire applying current in a first direction may attach to every other wire (or all “odd-numbered” wires), while a second feed wire applying current in a second direction may attach to the remaining wires (or all “even-numbered” wires). In some such embodiments, the two feed wires may run along the side of the membrane 205 like a radius line.

In some embodiments, the membrane tensioning apparatus 210 may utilize a single wire. In other embodiments, the membrane tensioning apparatus 210 may utilize a plurality of wires to achieve a desired tensioning and/or shaping effect on the membrane 205. In an embodiment in which a two-dimensional shaping effect on the membrane 205 is desired, a single wire may be utilized. In some such embodiments, additional wires may be utilized to achieve a desired tensioning effect. In an embodiment in which a three-dimensional shaping effect on the membrane 205 is desired (e.g., a parabolic shaping effect), a single wire or a plurality of wires may be utilized.

In some embodiments, the membrane tensioning apparatus 210 is used in space-based applications. In some embodiments, the membrane tensioning apparatus 210 is used as a reflector in a telescope or in a remote sensing satellite, as a diffraction grating, as a solar shield, as a solar sail, as a photon sieve, as a solar concentrator, or as or part of any suitable tool, or any combination thereof.

In some embodiments in which the membrane tensioning apparatus 210 is used as a diffraction grating, a rectangular membrane 205 is held taut by the force of one or more wires running through any portion of the grating or along the perimeter of the grating, which when charged, would stretch the membrane 205 flat. In some embodiments, the dimensions of the rectangular membrane 205 may range from a few meters to kilometers. Such a grating may be utilized for the purposes of simultaneous spectrographic analysis of all luminescent objects above a predetermined brightness level in large portions of the sky. The longer the diffraction grating, the higher the resolution it may provide. The wider the grating, the dimmer the light source it may show. In some embodiments, a one-kilometer grating may resolve a few milli-arcseconds, which is the planet-star separation for close-by systems. In some such embodiments, the diffraction grating dimensions may be maximized.

In some embodiments in which the membrane tensioning apparatus 210 is used as a solar shield, a large circle of membrane 205 is held taut by the force of one or more wires running along the circumference of the shield which, when charged, would stretch the membrane 205 out to its maximum extent.

In some embodiments in which the membrane tensioning apparatus 210 is used as a solar sail, the membrane 205 may be in the shape of a rectangle. In some such embodiments, one or more wires may be affixed about portions of the membrane 205 to tension it. In some such embodiments, the tension applied to the membrane by the applied current(s) may alter the shape of the solar sail. Altering may include folding in portions of or deforming the shape of the membrane 205 by applying or removing a current at portions of the one or more wire(s). For example, the applied current(s) may be controlled by a switching system which may allow the current(s) to run along a plurality of possible paths; this, in turn, may change the center of force of the sail and thus allow the device to go in different directions.

In some embodiments in which the membrane tensioning apparatus 210 is used as a photon sieve, the membrane 205 may include small circular holes centered on and spaced randomly along concentric circles, such that larger holes may be positioned in the circles of smaller radius and smaller holes may be positioned in the circles of larger radius. The holes may be positioned and sized such that light entering one side of the photon sieve would be focused on the opposite side of the photon sieve along a line perpendicular to the plane of the photon sieve and centered on the center of the photon sieve. The resultant focal point would be a function of the frequency of the entering light. In some such embodiments, the membrane 205 may be a circle held taut by the force of one or more wires running through the grating or along the circumference.

In some embodiments in which the membrane tensioning apparatus 210 is used as a solar concentrator, the membrane 205 may be tensioned by two or more wires into a parabolic shape. In some such embodiments, the solar concentrator may be utilized for generating electricity.

In some embodiments, in which the membrane tensioning apparatus 210 is used as a diffraction grating, the membrane includes a series of concentric circular rulings with gaps between them, similar to a Fresnel Zone Plate. The size of the gaps between the circular rulings decreases with increasing distance from the center, so that the incident radiation is bent at lesser angles towards the center of the grating and greater angles towards the perimeter. The incident radiation comes to a focus along a line perpendicular to the plane of the grating and centered on the center of the grating. The distance of the resultant focal point from the plane of the grating is a function of the frequency of incident light. In some embodiments, the membrane 205 may be a circle held taut by the force of one or more wires running through the grating or along the circumference.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for tensioning a membrane, the method comprising:
affixing a first wire to a first portion of the membrane;
affixing a second wire to a second portion of the membrane; and
tensioning the membrane between the first wire and the second wire, wherein tensioning comprises:
applying a first current in a first direction through the first wire; and
applying a second current in a second direction through the second wire, wherein repulsive magnetic fields are generated between the first wire and the second wire.

2. The method of claim 1, the method further comprising:
affixing the first wire about a perimeter of at least a first portion of the membrane; and
affixing the second wire about a perimeter of at least a second portion of the membrane,
wherein the second portion is contained within the first portion.

3. The method of claim 2, wherein the first wire and the second wire are positioned in concentric circles about the membrane.

4. The method of claim 1, wherein at least one surface of the membrane comprises a reflective material.

5. The method of claim 4, wherein the tensioned membrane forms a shape for focusing radiation incident on the reflective surface of the membrane onto a focal point.

6. The method of claim 4, the method further comprising:
focusing radiation incident on the reflective surface of the membrane onto a focal point.

7. The method of claim 1, wherein at least one surface of the membrane comprises an electrically conductive material.

8. The method of claim 7, wherein the at least one surface of the membrane comprises a metallic material.

9. The method of claim 1, wherein the membrane comprises a flexible material.

10. The method of claim 1, wherein each of the first wire and the second wire comprises a superconducting material.

11. The method of claim 1, wherein each of the first current and the second current is direct current.

12. The method of claim 1, wherein each of the first current and the second current is alternating current.

13. The method of claim 1, wherein affixing comprises using an adhesive material.

14. The method of claim 1, wherein affixing comprises photolithographically applying the first wire and the second wire to the membrane.

15. The method of claim 1, wherein the tensioned membrane forms a parabolic shape.

16. The method of claim 15, wherein the first wire and the second wire are positioned in concentric circles about the membrane.

17. The method of claim 1, wherein the tensioned membrane comprises a diffraction grating.

18. An apparatus for tensioning a membrane, the apparatus comprising:
a membrane;
a first wire affixed to a first portion of the membrane, the first wire configured to receive a first current in a first direction; and
a second wire affixed to a second portion of the membrane, the second wire configured to receive a second current in a second direction,
wherein applying the first current and the second current generates repulsive magnetic fields tensioning the membrane between the first wire and the second wire.

19. The apparatus as set forth in claim 18, wherein:
the first wire is affixed about a perimeter of at least a first portion of the membrane; and
the second wire is affixed about a perimeter of at least a second portion of the membrane, wherein the second portion is contained within the first portion.

20. The apparatus as set forth in claim 19, wherein the first wire and the second wire are positioned in concentric circles about the membrane.

21. The apparatus as set forth in claim 18, wherein at least one surface of the membrane comprises a reflective material.

22. The apparatus as set forth in claim 21, wherein the tensioned membrane forms a shape for focusing radiation incident on the reflective surface of the membrane onto a focal point.

23. The apparatus as set forth in claim 18, wherein at least one surface of the membrane comprises an electrically conductive material.

24. The apparatus as set forth in claim 23, wherein the at least one surface of the membrane comprises a metallic material.

25. The apparatus as set forth in claim 18, wherein the membrane comprises a flexible material.

26. The apparatus as set forth in claim 18, wherein each of the first wire and the second wire comprises a superconducting material.

27. The apparatus as set forth in claim 18, wherein each of the first current and the second current is direct current.

28. The apparatus as set forth in claim 18, wherein each of the first current and the second current is alternating current.

29. The apparatus as set forth in claim 18, wherein affixed comprises using an adhesive material.

30. The apparatus as set forth in claim 18, wherein affixed comprises photolithographically applying the first wire and the second wire to the membrane.

31. The apparatus as set forth in claim 18, wherein the tensioned membrane forms a parabolic shape.

32. The apparatus as set forth in claim 31, wherein the first wire and the second wire are positioned in concentric circles about the membrane.

33. The apparatus as set forth in claim 18, wherein the tensioned membrane comprises a diffraction grating.

34. The apparatus of claims 18, wherein affixed comprises embedding the first and second wires within the membrane.

35. The apparatus of claim 18, wherein the first wire and the second wire are positioned in concentric spiral shaped paths about the membrane.

36. The apparatus of claim 18, further comprising a bus feed for providing current to said first and second wires.

37. The apparatus of claim 18, wherein the membrane comprises a diffraction grating and wherein said diffraction grating comprises a plurality of concentric circular rulings with gaps between them, wherein the size of the gaps between the circular rulings decreases with increasing distance from the center of the grating, so that the incident radiation is bent at lesser angles towards the center of the grating and greater angles towards the perimeter of the grating.

38. The method of claim 1, wherein affixing comprises embedding the first and second wires within the membrane.

39. The method of claim 1, wherein the first wire and the second wire are positioned in concentric spiral shaped paths about the membrane.

40. The method of claim 1, further comprising providing a bus feed for providing current to said first and second wires.

41. A method for tensioning a portion of a membrane, the method comprising:
affixing a bent wire to a portion of the membrane;
applying a current in a first direction through the bent wire, thereby straitening the bent wire and tensioning the portion of the membrane.
